(19) United States
(12) Patent Application Publication
(10) Pub. No.: US 2026/0049236 A1
(43) Pub. Date: Feb. 19, 2026

(54) FUNCTIONALIZED POLYOLEFIN SOLVENT BLENDS FOR DISSIMILAR MATERIALS BONDING

(71) Applicant: CareFusion 303, Inc., San Diego, CA (US)

(72) Inventor: Zehra SEVINC, Long Grove, IL (US)

(21) Appl. No.: 18/808,678

(22) Filed: Aug. 19, 2024

(51) Int. Cl. C09J 151/06; C08F 214/06; C08F 222/06

(52) U.S. Cl. CPC C09J 151/06; C08F 214/06; C08F 222/06; C09J 2451/00

(57) ABSTRACT

An adhesive formulation may include a functionalized polyolefin having a polyolefin backbone with a molecular weight in a range from 60,000 Da to 90,000 Da, and a solvent or a solvent mixture present in a range from 52 wt % to 82 wt %. The polyolefin backbone is functionalized by addition of a polar side chain to the polyolefin backbone.

### TECHNICAL FIELD

The present disclosure generally relates to bonding dissimilar materials, in particular, of medical device components using adhesives.

### BACKGROUND

Interest for non-PVC in medical device area is growing due to increasing demands by regulatory agencies (EU MDRs), increasing customer demands due to environmental considerations, recyclability. Furthermore, the need for non-PVC materials in the medication delivery systems specifically for flexible application is growing due to its favorable properties of low absorption of drugs, chemical resistance, cleaner toxicology profile as compared with PVC. Regardless of the benefits of non-PVC material technologies, bonding of these low surface energy materials with polar substrate, often we call bonding ‘dissimilar’ materials, are still challenging. Poor bonding performance has been observed when solvent joining connectors with currently available flexible Non-PVC components such as tubing, drip chamber etc.

A common way for PVC tubing bonded to a rigid connector is with the use of solvents such as methyl ethyl ketone (MEK), cyclohexanone, cyclopentanone, methylene chloride, tetrahydrofuran (THF) or their mixture. The common rigid connectors include but not limited to, spike, male luer, needleless valve connector and coupler. The materials comprising these connectors are PC, ABS, mABS, acrylic, polyester, polystyrene, etc.

The common non-PVC technologies suitable for mediation delivery applications include sTPE, TPO, TPU, silicone. Among these non-PVC options, one of the promising tubing materials is SEBS based TPE because of the lower cost among other materials options, ample availability, resistance to leaching and durability.

### SUMMARY

The techniques disclosed herein advantageously can provide improved, bonding between dissimilar materials typically used in medical device components. Moreover, the techniques herein can eliminate the need for primer and an extra step of its application, and, the utilization of expensive adhesives before adhering dissimilar materials. Advantageously, common and inexpensive solvents can be used for joining parts that are suitable for high volume manufacturing or part assembly without compromising on safety of underlying medical device components. Additional advantages can include minimal changes in bulk properties of assembled parts such as clarity and suitability for medical delivery (e.g., low extractable/leachable, low toxicity) applications. Further advantages include ability to tailor the properties of the adhesive material to match the physical properties (e.g., rigidity, hardness) of the materials to be joined together.

In addition, the use of inexpensive solvents used in the disclosed technologies are practical to use in high volume manufacturing, and avoid separate primer application or heating steps. Even though specific use examples include the medical industry, these solutions have wide application potentials in other industries.

The technologies disclosed herein advantageously and significantly provide the ability to chemically bond dissimilar materials, increase bonding force when bonding dissimilar materials, provide ability to bond low surface energy substrates to high surface energy substrates, and offer customization for enhancing the performance and tailoring based on variety of substrate chemistries. Consequently, and advantageously, the technologies disclosed herein are suitable for high volume manufacturing by offering similar application times as compared with currently available solvent technologies utilizes on the manufacturing floor.

In one embodiment, the technology provides an adhesive formulation including a functionalized polyolefin having a polyolefin backbone with a molecular weight in a range from 60,000 Da to 90,000 Da and a solvent or a solvent mixture present in a range from 52 wt % to 82 wt %.

In another embodiment, the technology provides a method of bonding a first material to a second, dissimilar material. The method includes applying an adhesive formulation to a surface of one or both of the first and second materials and bonding the first material to the second material. The adhesive formulation includes a functionalized polyolefin having a polyolefin backbone with a molecular weight in a range from 60,000 Da to 90,000 Da and a solvent or a solvent mixture present in a range from 52 wt % to 82 wt %.

In another embodiment, the technology provides a method of bonding a first material to a second material. The method includes applying an adhesive formulation to a surface of one or both of the first and second materials, and bonding the first material to the second material. The first material is a low surface energy non-PVC substrate material, and the second material is a rigid polymer selected from the group consisting of polycarbonate, polyester, acrylic, polystyrene, acrylonitrile butadiene styrene (ABS), and methyl methacrylate ABS. The adhesive formulation includes a functionalized polyolefin, the functionalization including addition of a polar side chain to a polyolefin backbone, and a solvent or a solvent mixture.

Additional features and advantages of the subject technology will be set forth in the description below, and in part will be apparent from the description, or may be learned by practice of the subject technology. The advantages of the subject technology will be realized and attained by the structure particularly pointed out in the written description and embodiments hereof as well as the appended drawings.

It is to be understood that both the foregoing general description and the following detailed description are exemplary and explanatory and are intended to provide further explanation of the subject technology.

### BRIEF DESCRIPTION OF THE DRAWINGS

Various features of illustrative embodiments of the inventions are described below with reference to the drawings. The illustrated embodiments are intended to illustrate, but not to limit, the inventions. The drawings contain the following figures:

FIG. 1 shows a schematic of a mechanism of material interactions for substrate bonding in accordance with at least some embodiments of the present disclosure.

FIG. 2 shows an example of maleic anhydride functionalized polyolefin structure.

### DETAILED DESCRIPTION

It is understood that various configurations of the subject technology will become readily apparent to those skilled in the art from the disclosure, wherein various configurations of the subject technology are shown and described by way of illustration. As will be realized, the subject technology is capable of other and different configurations and its several details are capable of modification in various other respects, all without departing from the scope of the subject technology. Accordingly, the summary, drawings and detailed description are to be regarded as illustrative in nature and not as restrictive.

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, it will be apparent to those skilled in the art that the subject technology may be practiced without these specific details. In some instances, well-known structures and components are shown in block diagram form in order to avoid obscuring the concepts of the subject technology. Like components are labeled with identical element numbers for ease of understanding.

In one embodiment, an adhesive formulation includes a functionalized polyolefin and a solvent or a solvent mixture. The functionalized polyolefin may a polyolefin backbone with a molecular weight in a range from 60,000 Da to 90,000 Da. The solvent or the solvent mixture may be present in the adhesive formulation in a range from 52 wt % to 82 wt %.

The polyolefin backbone includes homopolymers produced from ethylene, propylene or higher alkylenes, or copolymers from two or more such monomers, unmodified polyolefins and modified polyolefins. Examples of the polyolefin backbone include, but are not limited to, ethylene vinyl acetate copolymer, polypropylene, polyethylene, and the like.

In some embodiments, the polyolefin backbone may be functionalized by addition of a polar side chain. Examples of polar side chains include, but are limited to, a chlorinated group, maleic anhydride, acrylic or a combination thereof. The chlorinated group may be a chlorinated saturated or unsaturated olefin group such as, for example, an alkyl, alkenyl, cycloalkyl, or an aromatic group with one or more hydrogens substituted by chloride. In some embodiments, up to 35% of the polyolefin backbone may be functionalized with the polar side chain. For example, up to about 5%, about 10%, about 15%, about 20%, about 25%, about 30%, about 35% or any amount between any two of these amounts.

As used herein, the term “about” is relative to the actual value stated, as will be appreciated by those of skill in the art, and allows for approximations, inaccuracies and limits of measurement under the relevant circumstances. In one or more aspects, the terms “about,” “substantially,” and “approximately” may provide an industry-accepted tolerance for their corresponding terms and/or relativity between items, such as a tolerance of from less than one percent to ten percent of the actual value stated, and other suitable tolerances.

Examples of functionalized polyolefins include, but are not limited to, SUPERCHLON E-723, E-673, and E-503 (CPOs, commercially available from Nippon Paper Chemicals); ADVANTIS 510W, CP 730-1, and CP 164-1 (non-CPOs, commercially available from Eastman); AUROREN AE 20 and AE-301 (non-CPOs, commercially available from Nippon Paper Chemicals); KOATTRO PB M 8510M and KOATTRO PB M 8911M (unmodified polyolefins, random copolymers of butene-1 with high ethylene content, commercially available from LyondellBasel); HARDLEN series (chlorinated polyolefins modified with maleic anhydride, including HARDLEN CY1321P, HARDLEN CY-9122P, and HARDLEN F-2P, commercially available from Toyobo Co., Ltd.), the TOYO TAC series (maleic anhydride-modified polypropylenes, including TOYO TAC PMA-L, TOYO TAC PMA-KE, TOYO TAC PMA-KH, and TOYO TAC PMA-T (commercially available from Toyobo Co., Ltd.); and TRAPYLEN series (CPOs, including TRAPYLEN 950S, TRAPYLEN 911S, TRAPYLEN 1395, and TRAPYLEN 1455, commercially available from Tramaco).

In some embodiments, the solvent or the solvent mixture includes cyclohexanone, methylcyclohexanone, butyl acetate, cyclopentanone, or a combination thereof. Other solvents such as, for example, methyl ethyl ketone, tetrahydrofuran, heptane, toluene, xylene, may also be used, but are to be avoided for medical applications because of potential toxicity.

The adhesive formulation may be formed by adding a suitable solvent to a powder (or a mixture of powders) of one or more of the functionalized polyolefins and swirling the mixing container for a period of time. The amount of time, and specific method of swirling or agitation needed to obtain the adhesive formulation will depend on the specific functionalized polyolefin, the specific solvent as well as the proportion of the solvent relative to the functionalized polyolefin. In some instances, the mixture may be heated to expedite the dissolution of the powders in the solvent. In some embodiments, the mixture may be heated to a temperature in a range from about 30° C. to about 90° C., e.g., to a temperature in a range from about 30° C. to about 40° C., about 35° C. to about 45° C., about 40° C. to about 50° C., about 45° C. to about 55° C., about 50° C. to about 60° C., about 55° C. to about 65° C., about 60° C. to about 70° C., about 65° C. to about 75° C., about 70° C. to about 80° C., about 75° C. to about 85° C., about 80° C. to about 90° C., or any combination thereof.

An aspect of the presently disclosed technology includes a method for binding a first material to a second dissimilar material. The method may include applying an adhesive formulation disclosed herein to a surface of one or both of the first and the second material, and bonding the first material to the second material.

Thus, the adhesive formulation may include a functionalized polyolefin having a polyolefin backbone with a molecular weight in a range from about 60,000 Da to about 90,000 Da, and a solvent or a solvent mixture present in a range from 52 wt % to 82 wt %. The functionalization may be addition of a polar side chain to up to about 35% of the polyolefin backbone. The polar side chain may include, but is not limited to, comprises a chlorinated group, maleic anhydride, acrylic or a combination thereof.

Examples of the solvent included in the adhesive formulation are, without limitation, cyclohexanone, methylcyclohexanone, butyl acetate, cyclopentanone, or a combination thereof.

In some embodiments, the first material may include a low surface energy non-PVC substrate material. Examples of the first material include, but are not limited to, non-PVC polyolefin polymers such as a styrenic based thermoplastic elastomer (TPE) or a styrenic based thermoplastic olefin (TPO).

In some embodiments, the second material may include a rigid amorphous polymer having a polar group. Examples of the second material include, but are not limited to, a polycarbonate or copolymer thereof, a polyacrylate or copolymer thereof such as a methylmethacrylate-acrylonitrile-butadiene-styrene (mABS) copolymer, or an acrylonitrile butadiene styrene (ABS) or copolymer thereof, or a derivative of any of the foregoing. Other examples of the second material may include polyester, acrylic, polystyrene.

In some embodiments, the adhesive formulation is applied on an interior surface of a first component made from the first material and a second component made from the second material is inserted into the interior of the second component such that an exterior surface of the second component contacts the interior surface of the first component. In some embodiments, the adhesive formulation is applied to the exterior of the second component, but not the interior surface of the first component. In some embodiments, the adhesive formulation is applied to both the interior surface of the first component and the exterior surface of the second component. In some embodiments, the first component is inserted into the second component such that the exterior surface of the first component contacts the interior surface of the second component. In such embodiments, the adhesive formulation may be suitably applied to one or both the exterior surface of the first component and the interior surface of the second component.

In some embodiments, at least the portion of the first and second components contacting each other may be treated to complete the bonding process. For example, the portion (or the entirety of the first and second components) may be heated or exposed to radiation. Heating may be to a temperature in a range from about 30° C. to about 150° C., e.g., about 30° C. to about 40° C., about 35° C. to about 45° C., about 40° C. to about 50° C., about 45° C. to about 55° C., about 50° C. to about 60° C., about 55° C. to about 65° C., about 60° C. to about 70° C., about 65° C. to about 75° C., about 70° C. to about 80° C., about 75° C. to about 85° C., about 80° C. to about 90° C., about 85° C. to about 95° C., about 90° C. to about 100° C., about 95° C. to about 105° C., about 100° C. to about 110° C., about 105° C. to about 115° C., about 110° C. to about 120° C., about 115° C. to about 125° C., about 120° C. to about 130° C., about 125° C. to about 135° C., about 130° C. to about 140° C., about 135° C. to about 145° C., about 140° C. to about 150° C., or any combination thereof. In some embodiments, the radiation may be visible light, ultraviolet (UV) light or other ionizing radiation such as, for example, X-rays or gamma rays.

Some examples of components where the presently disclosed technology may be used include, but are not limited to, medical infusion devices such as connectors and tubes.

Thus, another aspect of the presently disclosed technology, includes a method for bonding a low surface non-PVC substrate first material to a rigid polymer second material selected from the group consisting of polycarbonate, polyester, acrylic, polystyrene, acrylonitrile butadiene styrene (ABS), and methyl methacrylate ABS. The method includes applying an adhesive formulation to a surface of one or both of the first and second materials and bonding the first material to the second material. The adhesive formulation may include a functionalized polyolefin functionalized by addition of a polar side chain to a polyolefin backbone and a solvent or a solvent mixture.

As discussed herein, the adhesive formulation includes a functionalized polyolefin. Functionalization of the polyolefin backbones includes chlorination, maleic anhydride, acrylic or the combination thereof. This functionalization with high surface energy polar chemistries is designed to create an affinity with polar substrate materials that are otherwise incompatible with the polyolefin backbone. Moreover, the polyolefin backbone used in a solvent (blend) would interact with the low surface energy non-PVC substrate materials, for example TPE and TPO (i.e., the first material described herein). Without wishing to be bound by theory, even though the favorable chemical interactions created via this type of bridge chemistry is envisioned to be the primary mechanism of creating bond, solvent systems would facilitate the chain intermingling of dissimilar materials through action of diffusion and opening of the space within larger molecule chains at the interface to allow such intermingling.

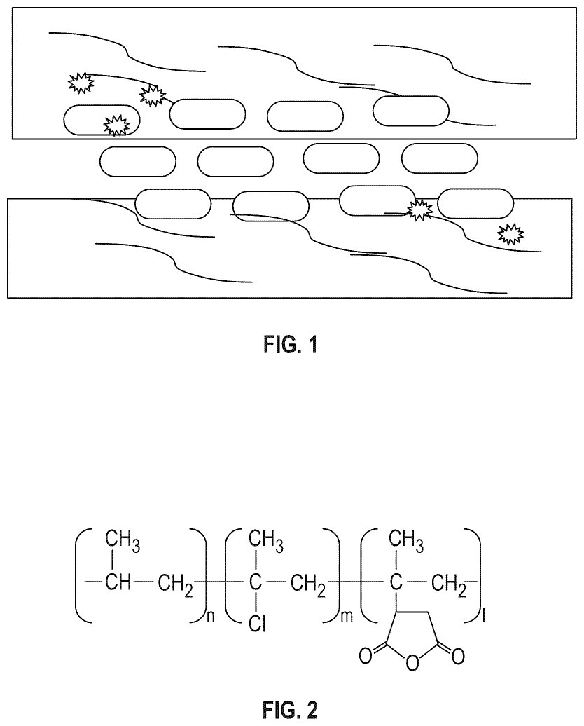

FIG. 1 shows a schematic of a mechanism of material interactions for substrate bonding in accordance with at least some embodiments of the present disclosure. The large ovals represent small solvent molecules, the thin wiggly lines represent one type of chemistry similar between first substrate and bonding agent, the thick wiggly lines represent the other type of chemistry similar between second substrate and bonding agent. The small stars represent the favorable interactions when affinity is created between molecules of alike.

FIG. 2 shows an example of maleic anhydride functionalized polyolefin structure.

Experimental data from the Examples set forth herein evidences that bonding dissimilar materials using the technology disclosed herein provides an ability to chemically bond chemically dissimilar materials such as, for example, bond materials having low surface energy substrates to materials having high surface energy substrates, and also provides an increased bonding force. The presently disclosed technology also allows for customization for enhancing the performance and tailoring based on a wide variety of substrate chemistries. Additionally, and advantageously, the technology disclosed herein is suitable for high volume manufacturing by offering similar application times as compared to currently available technologies for bonding dissimilar materials while providing a higher bonding force.

While specific examples of functionalized polyolefins and solvents are disclosed herein, adhesive formulations including other polyolefin backbones, other functional groups, other solvent types, or solvent mixtures with varying blend ratios, are contemplated within the scope of the present disclosure.

### EXAMPLES

Luer extension tube pull force testing was performed in order to evaluate Neo tubing bonded with Hardlen or Toyotac adhesives with or without MEK baked primer. Sample details used for the testing are shown in Table 1.

TABLE 1
Sample details

| Part | Lot |
|---|---|
| MD42275 Tubing | NX00342 |
| TC0002264 Luer | 0930120 |
| Methyl Ethyl Ketone | 202681 |
| Hardlen F2-MB | 001262 |
| Hardlen NZ-1004 | 910281 |
| Toyotac PMA L | 912-12 |
| Toyotac PMA KH | 910-28 |
| Toyotac PMA LE | 17A18 |
| Toyotac PMA KE | 907-24 |
| Methylcyclohexane | A0416513 |
| Butyl Acetate | 201788 |

### Example 1: Preparing an Adhesive Formulation

Adhesives used in all Toyo-Tac™ Formulations required mixing Toyo-tac powders with solvents in a 150 ml glass flask prior to use in assembly; formulations are specified in Table 2. Stir plate was used with magnetic stirrer and set to 350 rpm while adding ingredients and then to 200 rpm for the rest of the mixing process. Heat was set to 75° C. No filtration system was used. It took 80-90 min to dissolve powder particles after all ingredients were added. Formulation-specific procedures are given below:
a. Formulation 1: Solvent was added first, followed by slowly adding the powder over about 15 minutes and gently swirling the mixing container occasionally.
b. Formulation 2: Solvent was added first, followed by slowly adding the powder over about 15 minutes and stirred with a small metal spoon to break up chunks in the beginning.
c. Formulations 3 & 4: Powder was added first, followed by the solvent via funnel, and stirred with a metal spoon to break up chunks in the beginning.

Adhesives used in Hardlen groups did not require any advance preparation before use in assembly.

TABLE 2
Examples of custom solvent blend formulations
with functionalized polyolefins

| | Formu- | | Formu- | | Formu- | | Formu- | |
|---|---|---|---|---|---|---|---|---|
| Powder | lation 1 | | lation 2 | | lation 3 | | lation 4 | |
| PMA-L | 4.999 | g | none | | 4.997 | g | none | |
| PMA-LE | none | | 5.001 | g | none | | 5.005 | g |
| PMA-KH | 10.002 | g | none | | 5.005 | g | 4.995 | g |
| PMA-KE | none | | 10.004 | g | 4.998 | g | 4.998 | g |
| Methyl- | 76.5 | mL | 76.5 | mL | 76.5 | mL | 76.5 | mL |
| cyclohexane | | | | | | | | |
| Butyl Acetate | 8.5 | mL | 8.5 | mL | 8.5 | mL | 8.5 | mL |
| Total solid | 15.001 | g | 15.005 | g | 15.000 | g | 14.998 | g |
| amount | | | | | | | | |
| Total solvent | 85 | mL | 85 | mL | 85 | mL | 85 | mL |
| amount | | | | | | | | |
| (MCH/Butyl | | | | | | | | |
| Acetate) | | | | | | | | |

### Example 2: Assembly of all Sample Groups Except for Hardlen F2-MB

In order to check adhesive thickness, i.e., viscosity, a polyswab was dipped into the adhesive and then taken out. Dripping was observed in all instances; no dripping indicates that the adhesive is too thick and may require dilution.

In order to check wettability, the adhesive on the polyswab was applied on a representative surface area to visually check for any difficulties in application, including clumping or separation by dabbing with polyswab on a plastic cup. Observations may lead to revision of the application technique. Record the technique utilized if variation of this technique is used.

The polyswab was dipped in the adhesive and immediately used to apply on the tube outer surface only using a brush-like motion.

After application of adhesive, the tubing was inserted inside the connector. Time needed to apply adhesive solutions on the tubing was recorded, starting from when the swab was picked up until the tubing was fully inserted inside the connector. Sub-assemblies were left on a tray under hood until testing.

### Example 3: Assembly of Hardlen F2-MB Sample Group

Using polyswab, F2-MB Hardlen adhesion promoter was first applied as a thin layer on the tubing (thickness was not controlled or measured as part of this first Proof-of-Concept, though thickness is a potential factor). The tubing after application of the F2-MB coating was conditioned in 55° C. oven for 50 min and then left for 10 min at room temperature to cool. The coated tubing section was then dipped into MEK solvent and taken out for dabbing the excess solvent on a piece of lab clothing or absorbing paper before being pushed into the pocket of the connector while wet (not allowing solvent evaporation).

### Example 4: Instron Testing

Universal testing (Instron) program Bluehill, version 3.76.4926 were used for performing pull force testing using run parameters detailed in Table 3. Luer extension tube pull force results by sample group are shown in Table 3, along with number of samples exhibiting each failure mode (TPO=Tube Pull Out, BAN=Break At Nose), visual assessment of where adhesive residue was present (i.e. on connector, tube or both), adhesives/solvents/primers used, and application time (Hardlen F2-MB group includes time needed for application of both F2-MB and MEK).

TABLE 3
Universal testing (Instron) parameters

| Test Method - CTP-43 | | Tension Test at 5 In/min w/500N w/1″ gap | |
|---|---|---|---|
| Pre-Test | | Auto Balance Load | |
| Test | Ramp 1 | Control Mode 1: | Tensile Extension |
| | | Crosshead Speed (in/min): | 5 inch/minute |
| | | Criteria 1: | % Peak Load |
| End of Test | Test 1 | Load drops by %: | 95% |
| | | Load Threshold | .15 lbs |
| | | Action: | Return |
| | | Data Capture: | Manual |
| Data | Criteria 1 | Channel 1: | Time |
| | | Interval 1 (ms): | 50 ms |
| | Criteria 2 | Channel 2: | NA |
| | | Interval 2 (N): | NA |

The universal testing was performed at 5 in/min with a 1 inch gap. Pull force results by sample group are detailed in Table 5, along with failure mode (TPO=Tube Pull Out, BAN=Break at Nose) and visual assessment of where adhesive residue was present (on connector, on tube or on both), along with application time (the time the swap was picked up until tube was filly inserted). The formulation details are in Table 2.

The results of universal testing (Instron) are detailed in Table 4:

TABLE 4
Universal testing (Instron) results for each sample group:

| | | | Primer/ | | | Adhesive on | Application |
|---|---|---|---|---|---|---|---|
| Sample | Sample | Adhesive/ | MCH & Butyl | Max | Failure | Connector, | Time |
| Group | Number | Powder | Acetate | (lbf) | Mode | Tube or Both | (seconds) |
| Formulation 1 | 1 | PMA-L | MCH & | 9.38 | TPO | Connector | 8 |
| | 2 | PMA-KH | Butyl | 10.32 | | | 6 |
| | 3 | | Acetate | 9.24 | | | 6 |
| | 4 | | | 4.85 | | | 6 |
| | 5 | | | 5.08 | | | 6 |
| | 6 | | | 8.91 | | | 6 |
| | 7 | | | 8.53 | | | 5 |
| | 8 | | | 4.85 | | | 5 |
| | 9 | | | 5.24 | | | 5 |
| | 10 | | | 7.19 | | | 5 |
| | Mean | | | 7.36 | | | N/A |
| | Std. Deviation | | | 2.17 | | | |
| Formulation 2 | 1 | PMA-LE | MCH & | 6.11 | TPO | Connector | 7 |
| | 2 | PMA-KE | Butyl | 5.03 | | | 6 |
| | 3 | | Acetate | 11.33 | | | 6 |
| | 4 | | | 12.79 | | | 6 |
| | 5 | | | 6.75 | | | 5 |
| | 6 | | | 9.90 | | | 6 |
| | 7 | | | 5.14 | | | 6 |
| | 8 | | | 8.74 | | | 5 |
| | 9 | | | 5.47 | | | 5 |
| | 10 | | | 8.91 | | | 6 |
| | Mean | | | 8.02 | | | N/A |
| | Std. Deviation | | | 2.74 | | | |
| Formulation 3 | 1 | PMA-L | MCH & | 8.08 | TPO | Connector | 8 |
| | 2 | PMA-KH | Butyl | 6.25 | | | 6 |
| | 3 | PMA-KE | Acetate | 4.43 | | | 5 |
| | 4 | | | 7.31 | | | 6 |
| | 5 | | | 8.45 | | | 6 |
| | 6 | | | 4.91 | | | 6 |
| | 7 | | | 5.48 | | | 6 |
| | 8 | | | 9.15 | | | 6 |
| | 9 | | | 8.70 | | | 5 |
| | 10 | | | 4.86 | | | 5 |
| | Mean | | | 6.76 | | | N/A |
| | Std. Deviation | | | 1.79 | | | |
| Formulation 4 | 1 | PME-LE | MCH & | 8.41 | TPO | Connector | 7 |
| | 2 | PMA-KH | Butyl | 9.08 | TPO | | 6 |
| | 3 | PMA-KE | Acetate | 9.18 | TPO | | 5 |
| | 4 | | | 10.27 | TPO | | 5 |
| | 5 | | | 10.30 | TPO | | 5 |
| | 6 | | | 8.52 | TPO | | 5 |
| | 7 | | | 11.51 | BAN | | 5 |
| | 8 | | | 10.71 | TPO | | 5 |
| | 9 | | | 10.11 | TPO | | 6 |
| | 10 | | | 9.20 | TPO | | 5 |
| | Mean | | | 9.73 | N/A | | N/A |
| | Std. Deviation | | | 1.00 | | | |
| Hardlen | 1 | Hardlen | Primed | 5.68 | TPO | Connector | 5 (F2-MB) + |
| F2-MB | | F2-MB | with | | | | 2 (MEK) = 7 |
| | 2 | | F2-MB, | 6.31 | | | 5 + 2 = 7 |
| | 3 | | put in | 5.40 | | | 4 + 2 = 6 |
| | 4 | | oven at | 5.39 | | | 4 + 3 = 7 |
| | 5 | | 55 C. | 4.67 | | | 5 + 5 = 10 |
| | 6 | | for 50 | 5.74 | | | 5 + 4 = 9 |
| | 7 | | minutes | 5.22 | | | 5 + 5 = 10 |
| | 8 | | then | 5.91 | | | 5 + 5 = 10 |
| | 9 | | MEK | 6.45 | | | 4 + 6 = 10 |
| | 10 | | applied | 5.63 | | | 4 + 5 = 9 |
| | Mean | | | 5.64 | | | N/A |
| | Std. Deviation | | | 0.52 | | | |
| Hardlen NZ | 1 | Hardlen | N/A | 2.46 | TPO | Connector | 10 |
| 1004 | 2 | NZ 1004 | | 2.27 | | | 9 |
| | 3 | | | 2.00 | | | 7 |
| | 4 | | | 2.24 | | | 7 |
| | 5 | | | 2.30 | | | 7 |
| | 6 | | | 1.99 | | | 6 |
| | 7 | | | 2.61 | | | 6 |
| | 8 | | | 2.61 | | | 7 |
| | 9 | | | 2.28 | | | 6 |
| | 10 | | | 2.42 | | | 7 |
| | Mean | | | 2.32 | | | N/A |
| | Std. Deviation | | | 0.22 | | | |

TABLE 5
Summary of testing results:

| | | Std | | Adhesive on | | |
|---|---|---|---|---|---|---|
| | Mean | Dev | Failure | Connector, | Application | |
| Sample Group | (lbf) | (lbf) | Mode | Tube or Both | Time | |
| Formulation 1 | 7.36 | 2.17 | 10 TPO | Connector | 5-8 | seconds |
| Formulation 2 | 8.02 | 2.74 | 10 TPO | Connector | 5-7 | seconds |
| Formulation 3 | 6.76 | 1.79 | 10 TPO | Connector | 5-8 | seconds |
| Formulation 4 | 9.73 | 1.00 | 9 TPO | Connector | 5-7 | seconds |
| | | | 1 BAN | | | |
| Hardlen F2-MB | 5.64 | 0.52 | 10 TPO | Connector | 6-10 | seconds |
| Hardlen NZ 1004 | 2.32 | 0.22 | 10 TPO | Connector | 6-10 | seconds |

Table 6 summarizes the physical properties of the main formulation ingredients and performance improvement relative to baseline solvent technology.

TABLE 6
Formulation adhesion performance compared with baseline solvent technology:

| | | | | | | | | Mean | Std |
|---|---|---|---|---|---|---|---|---|---|
| | | | | Solid | (Melt) | Chlori- | | Bond | Bond |
| | | | MW, | Content, | Viscosity | nation, | MAH, | Force, | Force, |
| Grade | Chemistry | Solvent | Dalton | wt % | mPa s @25 C. | % | wt % | lbf | lbf |
| NA | Solvent | MEK | 72.11 | 0 | 0.4 | 0 | 0 | 4.2 | 0.37 |
| F-2MB | MAH-CPO solvent borne | 70 MCH/ | 65000 | 20 | 70 | 20 | 1.6 | 8.3 | 1.65 |
| | | 30 BuOAC | | | | | | | |
| Toyotac PMA-L | MAH-PO (2,5-Furandione, | None | 75000 | 100 | 2500 | 0 | 1.5 | NA | NA |
| | polymer with 1-butene | | | | | | | | |
| | and 1-propene) | | | | | | | | |
| Toyotac PMA-LE | MAH-PO (modified | None | NA | 100 | NA | 0 | Not | NA | NA |
| | polyolefin) | | | | | | available | | |
| Toyotac PMA-KH | MAH-PO (2,5-Furandione, | None | 90000 | 100 | 4000-5000 | 0 | 1 | NA | NA |
| | polymer with 1-butene | | | | | | | | |
| | and 1-propene) | | | | | | | | |
| Toyotac PMA-KE | MAH-PO (modified | None | 60000 | 100 | NA | 0 | Not | NA | NA |
| | polyolefin) | | | | | | available | | |
| Formulation 1 | MAH-PO (2,5-Furandiion, | 90 MCH/ | NA | 18 | NA | 0 | Not | 7.36 | 2.17 |
| (PMA-L/-KH) | polymer with 1-butene | 10 BuOAC | | | | | available | | |
| | and 1-propene) | | | | | | | | |
| Formulation 2 | MAH-PO (modified | 90 MCH/ | NA | 18 | NA | 0 | Not | 8.02 | 2.74 |
| (PMA-LE/-KE) | polyolefin) | 10 BuOAC | | | | | available | | |
| Formulation 3 | MAH-PO | 90 MCH/ | NA | 18 | NA | 0 | Not | 6.76 | 1.79 |
| (PMA-L/-KH/-KE) | | 10 BuOAC | | | | | available | | |
| Formulation 4 | MAH-PO | 90 MCH/ | NA | 18 | NA | 0 | Not | 9.73 | 1 |
| (PMA-LE/-KH/-KE) | | 10 BuOAC | | | | | available | | |

Table 6 illustrates that the adhesive formulations disclosed herein result in significantly higher standard bond force when compared to using only a solvent for bonding the materials.

### Illustration of Subject Technology as Clauses

Various examples of aspects of the disclosure are described as numbered clauses (1, 2, 3, etc.) for convenience. These are provided as examples, and do not limit the subject technology. Identifications of the figures and reference numbers are provided below merely as examples and for illustrative purposes, and the clauses are not limited by those identifications.

Clause 1. An adhesive formulation comprising a functionalized polyolefin having a polyolefin backbone with a molecular weight in a range from 60,000 Da to 90,000 Da; and a solvent or a solvent mixture present in a range from 52 wt % to 82 wt %.

Clause 2. The adhesive formulation of clause 1, wherein functionalization in the functionalized polyolefin includes addition of a polar side chain to the polyolefin backbone.

Clause 3. The adhesive formulation of clause 2, wherein the polar side chain comprises a chlorinated group, maleic anhydride, acrylic or a combination thereof.

Clause 4. The adhesive formulation of any of clauses 1-3, wherein the solvent comprises cyclohexanone, methylcyclohexanone, butyl acetate, cyclopentanone, or a combination thereof.

Clause 5. The adhesive formulation of any of clauses 1-4, wherein up to 35% of the polyolefin backbone is functionalized in the functionalized polyolefin.

Clause 6. A method of bonding a first material to a second, dissimilar material, the method includes applying an adhesive formulation to a surface of one or both of the first and second materials. The adhesive formulation comprises a functionalized polyolefin having a polyolefin backbone with a molecular weight in a range from 60,000 Da to 90,000 Da, and a solvent or a solvent mixture present in a range from 52 wt % to 82 wt %. The method further includes bonding the first material to the second material.

Clause 7. The method of clause 6, wherein the first material comprises a low surface energy non-PVC substrate material.

Clause 8. The method of clause 6, wherein the first material is a low surface energy non-PVC substrate material, and the second material is a rigid polymer selected from the group consisting of polycarbonate, polyester, acrylic, polystyrene, acrylonitrile butadiene styrene (ABS), and methylmethacrylate ABS.

Clause 9. The method of any of clauses 6-8, wherein functionalization in the functionalized polyolefin includes addition of a polar side chain to the polyolefin backbone.

Clause 10. The method of any of clauses 6-9, wherein the polar side chain comprises a chlorinated group, maleic anhydride, acrylic or a combination thereof.

Clause 11. The method of any of clauses 6-10, wherein up to 35% of the polyolefin backbone is functionalized in the functionalized polyolefin.

Clause 12. The method of any of clauses 6-11, wherein the solvent comprises cyclohexanone, methylcyclohexanone, butyl acetate, cyclopentanone, or a combination thereof.

Clause 13. The method of clause 6, wherein the polar side chain comprises chlorinated group and the solvent comprises butyl acetate and methylcyclohexanone.

Clause 14. A method of bonding a first material to a second material, the method comprising applying an adhesive formulation to a surface of one or both of the first and second materials, and bonding the first material to the second material. The first material is a low surface energy non-PVC substrate material. The second material is a rigid polymer selected from the group consisting of polycarbonate, polyester, acrylic, polystyrene, acrylonitrile butadiene styrene (ABS), and methyl methacrylate ABS. The adhesive formulation comprises: a functionalized polyolefin, the functionalization including addition of a polar side chain to a polyolefin backbone, and a solvent or a solvent mixture.

Clause 15. The method of clause 14, wherein a polyolefin backbone of the functionalized polyolefin has a molecular weight in a range from 60,000 Da to 90,000 Da.

Clause 16. The method of clause 14, wherein the solvent or the solvent mixture in the adhesive formulation is present in a range from 52 wt % to 82 wt %.

Clause 17. The method of any of clauses 14-16, wherein up to 35% of a polyolefin backbone of the functionalized polyolefin is functionalized.

Clause 18. The method of any of clauses 14-17, wherein the solvent comprises cyclohexanone, methylcyclohexanone, butyl acetate, cyclopentanone, or a combination thereof.

Clause 19. The method of any of clauses 14-18, wherein the polar side chain is selected from the group consisting of chlorinated group, maleic anhydride, acrylic and a combination thereof.

Clause 20. The method of any of clauses 14, wherein the polar side chain comprises chlorinated group and the solvent comprises butyl acetate and methylcyclohexanone.

### Further Considerations

In some embodiments, any of the clauses herein may depend from any one of the independent clauses or any one of the dependent clauses. In one aspect, any of the clauses (e.g., dependent or independent clauses) may be combined with any other one or more clauses (e.g., dependent or independent clauses). In one aspect, a claim may include some or all of the words (e.g., steps, operations, means or components) recited in a clause, a sentence, a phrase or a paragraph. In one aspect, a claim may include some or all of the words recited in one or more clauses, sentences, phrases or paragraphs. In one aspect, some of the words in each of the clauses, sentences, phrases or paragraphs may be removed. In one aspect, additional words or elements may be added to a clause, a sentence, a phrase or a paragraph. In one aspect, the subject technology may be implemented without utilizing some of the components, elements, functions or operations described herein. In one aspect, the subject technology may be implemented utilizing additional components, elements, functions or operations.

The foregoing description is provided to enable a person skilled in the art to practice the various configurations described herein. While the subject technology has been particularly described with reference to the various figures and configurations, it should be understood that these are for illustration purposes only and should not be taken as limiting the scope of the subject technology.

There may be many other ways to implement the subject technology. Various functions and elements described herein may be partitioned differently from those shown without departing from the scope of the subject technology. Various modifications to these configurations will be readily apparent to those skilled in the art, and generic principles defined herein may be applied to other configurations. Thus, many changes and modifications may be made to the subject technology, by one having ordinary skill in the art, without departing from the scope of the subject technology.

It is understood that the specific order or hierarchy of steps in the processes disclosed is an illustration of exemplary approaches. Based upon design preferences, it is understood that the specific order or hierarchy of steps in the processes may be rearranged. Some of the steps may be performed simultaneously. The accompanying method claims present elements of the various steps in a sample order and are not meant to be limited to the specific order or hierarchy presented.

As used herein, the phrase “at least one of” preceding a series of items, with the term “and” or “or” to separate any of the items, modifies the list as a whole, rather than each member of the list (i.e., each item). The phrase “at least one of” does not require selection of at least one of each item listed; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

Furthermore, to the extent that the term “include,” “have,” or the like is used in the description or the claims, such term is intended to be inclusive in a manner similar to the term “comprise” as “comprise” is interpreted when employed as a transitional word in a claim.

In one or more aspects, the terms “about,” “substantially,” and “approximately” may provide an industry-accepted tolerance for their corresponding terms and/or relativity between items, such as from less than one percent to five percent.

The word “exemplary” is used herein to mean “serving as an example, instance, or illustration.” Any embodiment described herein as “exemplary” is not necessarily to be construed as preferred or advantageous over other embodiments.

A reference to an element in the singular is not intended to mean “one and only one” unless specifically stated, but rather “one or more.” Pronouns in the masculine (e.g., his) include the feminine and neuter gender (e.g., her and its) and vice versa. The term “some” refers to one or more. Underlined and/or italicized headings and subheadings are used for convenience only, do not limit the subject technology, and are not referred to in connection with the interpretation of the description of the subject technology. All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description.

Although the detailed description contains many specifics, these should not be construed as limiting the scope of the subject technology but merely as illustrating different examples and aspects of the subject technology. It should be appreciated that the scope of the subject technology includes other embodiments not discussed in detail above. Various other modifications, changes and variations may be made in the arrangement, operation and details of the method and apparatus of the subject technology disclosed herein without departing from the scope of the present disclosure. Unless otherwise expressed, reference to an element in the singular is not intended to mean “one and only one” unless explicitly stated, but rather is meant to mean “one or more.” In addition, it is not necessary for a device or method to address every problem that is solvable (or possess every advantage that is achievable) by different embodiments of the disclosure in order to be encompassed within the scope of the disclosure. The use herein of “can” and derivatives thereof shall be understood in the sense of “possibly” or “optionally” as opposed to an affirmative capability.

What is claimed is:

1. An adhesive formulation comprising:
a functionalized polyolefin having a polyolefin backbone with a molecular weight in a range from 60,000 Da to 90,000 Da; and
a solvent or a solvent mixture present in a range from 52 wt % to 82 wt %.

2. The adhesive formulation of claim 1, wherein functionalization in the functionalized polyolefin includes addition of a polar side chain to the polyolefin backbone.

3. The adhesive formulation of claim 2, wherein the polar side chain comprises a chlorinated group, maleic anhydride, acrylic or a combination thereof.

4. The adhesive formulation of claim 1, wherein the solvent comprises cyclohexanone, methylcyclohexanone, butyl acetate, cyclopentanone, or a combination thereof.

5. The adhesive formulation of claim 1, wherein up to 35% of the polyolefin backbone is functionalized in the functionalized polyolefin.

6. A method of bonding a first material to a second, dissimilar material, the method comprising:
applying an adhesive formulation to a surface of one or both of the first and second materials, the adhesive formulation comprising:
a functionalized polyolefin having a polyolefin backbone with a molecular weight in a range from 60,000 Da to 90,000 Da, and
a solvent or a solvent mixture present in a range from 52 wt % to 82 wt %; and
bonding the first material to the second material.

7. The method of claim 6, wherein the first material comprises a low surface energy non-PVC substrate material.

8. The method of claim 6, wherein the first material is a low surface energy non-PVC substrate material, and the second material is a rigid polymer selected from the group consisting of polycarbonate, polyester, acrylic, polystyrene, acrylonitrile butadiene styrene (ABS), and methylmethacrylate ABS.

9. The method of claim 6, wherein functionalization in the functionalized polyolefin includes addition of a polar side chain to the polyolefin backbone.

10. The method of claim 9, wherein the polar side chain comprises a chlorinated group, maleic anhydride, acrylic or a combination thereof.

11. The method of claim 9, wherein the polar side chain comprises chlorinated group and the solvent comprises butyl acetate and methylcyclohexanone.

12. The method of claim 6, wherein up to 35% of the polyolefin backbone is functionalized in the functionalized polyolefin.

13. The method of claim 6, wherein the solvent comprises cyclohexanone, methylcyclohexanone, butyl acetate, cyclopentanone, or a combination thereof.

14. A method of bonding a first material to a second material, the method comprising:
applying an adhesive formulation to a surface of one or both of the first and second materials; and
bonding the first material to the second material,
wherein the first material is a low surface energy non-PVC substrate material,
wherein the second material is a rigid polymer selected from the group consisting of polycarbonate, polyester, acrylic, polystyrene, acrylonitrile butadiene styrene (ABS), and methyl methacrylate ABS, and
wherein the adhesive formulation comprises:
a functionalized polyolefin, the functionalization including addition of a polar side chain to a polyolefin backbone, and
a solvent or a solvent mixture.

15. The method of claim 14, wherein polyolefin backbone of the functionalized polyolefin has a molecular weight in a range from 60,000 Da to 90,000 Da.

16. The method of claim 14, wherein the solvent or the solvent mixture in the adhesive formulation is present in a range from 52 wt % to 82 wt %.

17. The method of claim 14, wherein up to 35% of a polyolefin backbone of the functionalized polyolefin is functionalized.

18. The method of claim 14, wherein the solvent comprises cyclohexanone, methylcyclohexanone, butyl acetate, cyclopentanone, or a combination thereof.

19. The method of claim 14, wherein the polar side chain is selected from the group consisting of chlorinated group, maleic anhydride, acrylic and a combination thereof.

20. The method of claim 14, wherein the polar side chain comprises chlorinated group and the solvent comprises butyl acetate and methylcyclohexanone.
